(19) United States
(12) Patent Application Publication
(10) Pub. No.: US 2025/0190998 A1
(43) Pub. Date: Jun. 12, 2025

(54) AIRPORT ACCREDITATION PROCESS

(71) Applicant: Gregory Thomas, Edgewood, WA (US)

(72) Inventor: Gregory Thomas, Edgewood, WA (US)

(21) Appl. No.: 18/533,990

(22) Filed: Dec. 8, 2023

Related U.S. Application Data
(60) Provisional application No. 63/422,099, filed on Nov. 3, 2022.

(51) Int. Cl. G06Q 30/018; G06Q 50/40

(52) U.S. Cl. CPC G06Q 30/018; G06Q 50/40

(57) ABSTRACT

An eight-phase method for an airport accreditation process for an airport to meet specific airport standards that earns the airport the title of “World Class”. Phase 1 is of interest and contract by the airport. Phase 2 is of file maintenance. Phase 3 is of self-assessment. Phase 4 is of on-site assessment and evaluation. Phase 5 is of a review by the Accreditation Board of Commissioners. Phase 6 is of an Executive Director review. Phase 7 is of an award. Phase 8 is of re-accreditation.

### CROSS-REFERENCE TO RELATED APPLICATIONS

This application claims benefit to provisional application U.S. 63/422,099 filed on Nov. 3, 2022, and is incorporated in its entirety.

### BACKGROUND OF THE INVENTION

The present invention generally relates to accreditation processes. More specifically, the present invention relates to an airport accreditation process.

The International Association of Airport Accreditation (IAAA) was created to elevate and celebrate airports that are using the “best practices” in airport management. The accreditation standards that an airport, regardless of index, FAA Part 139 or non-Part 139 governance, could obtain and support with documentation, records, policies and procedures, if met would deem that airport to be “World Class”. These standards apply components from many aspects of airport administration best practices and standards used by the American Association of Airport Executives (AAAE), Airport Council International (ACI) and others to create the best examples of standards that an airport could strive to meet. The purpose of accreditation is to identify and apply professional airport industry standards in a review format. An airport meeting the “World Class” standards could use this ranking as a business magnet for potential customers. It would also instill pride, positive morale in the staff and support from upper airport management, owners and the surrounding communities. The goal is to be certified as “World Class” by the IAAA for these standards and to operate under the industries “Best Practices”. The plan also allows for changes and innovations in the application of standards. It is an on-going improvement process, with the best practices from one Airport available to help other airports to achieve that same goal.

Currently there is no whole airport accreditation process that covers each discipline in airport management (such as business systems, operations, maintenance, engineering) and the areas these affect, such as pollution and energy conservation and airport profit margins. Currently many airports perform “World Class” acts and have a goal of being “World Class”, but there are no unifying steps to identify the components and standards as well as the policies, procedures and proofs of attaining “World Class” status.

It is an object of the present invention to provide a plan of a whole airport accreditation process.

### SUMMARY OF THE INVENTION

An eight-phase method for an airport accreditation process for an airport to meet specific airport standards that earns the airport the title of “World Class”. Phase 1 is of interest and contract by the airport with IAAA. Phase 2 is of file maintenance. Phase 3 is of self-assessment. Phase 4 is of on-site assessment and evaluation. Phase 5 is of a review by the Accreditation Board of Commissioners. Phase 6 is of an Executive Director review. Phase 7 is of an award. Phase 8 is of re-accreditation.

### DETAILED DESCRIPTION OF THE INVENTION

The present invention is an airport accreditation process for any airport to meet specific airport standards that when reached, would earn the airport the title of “World Class”. The airport accreditation process includes standards, the process of verification, the training of mentors, assessors and recognition for airports to achieve “World Class” status. Meeting the standards of the airport accreditation process will increase air travel safety, efficiency, public trust, local acceptance and make every airport that is accredited a stronger more transparent business concern. Currently there are standards that are recognized by industry leaders as being pertinent to business success and qualify as industry “Best Practices”. These standards may change over time to keep up with growing trends in modern aviation (such as vertiports, drones, lithium battery development and carbon fiber materials). The use of these current and future technologies will increase safety, fuel efficiencies, reduce pollution and increase profit margins in the airports of the future.

The accreditation process occurs in eight phases. The eight phases include Interest and contract; file maintenance; self-assessment; on-site assessment and evaluation; Accreditation Board of Commissioners review; Executive Director review, awards; and re-accreditation.

Phase 1 is the interest and contract phase. During the interest and contract phase, airport staff work with the Director of Professional Services to develop guide lines for the particular airport (Part 139 or non-139) and staff/resources. There are fees associated with the accreditation program: application fees and on-site costs, travel and lodging. The application fee for all airports is submitted, along with a signed contract, following the airport's successful completion of all current IAAA accreditation standards.

Airports are subject to re-accreditation every 3 years. Airports will be notified of their upcoming re-accreditation by the Director of Professional Services. On-site assessment fees are related to the accreditation inspection process once assessors arrive at an airport and are involved after the on-site assessment and vary by department and availability of assessors. Airports seeking accreditation agree to pay the travel costs associated with bringing in Assessors. The IAAA bills employee staff time needed to facilitate airport accreditation. Every effort is made to utilize assessors that are located close to the requesting airport to help minimize these costs.

Once a contract is signed with IAAA by airports seeking initial accreditation they will have one year to complete their onsite assessment. Airports are strongly encouraged to work closely with their mentor and the Director of Professional Services to ensure proper timing of the accreditation contract. Airports not being able to successfully complete their on-site assessment within one year must re-apply, submit the application fee and will be subject to any changes in the IAAA accreditation standards in effect at the time of re-application.

All current IAAA accreditation airports are subject to re-accreditation every 3 years. Airports will be notified of the up-and-coming re-accreditation by the Director of Professional services in the fall prior to the re-accreditation year. Airports will have to successfully complete a re-accreditation on-site. Extensions for re-accreditation airports will not be considered. Those airports not re-accrediting by a pre-determined date are suspended the following year and must re-apply as a new accrediting airport the second year. During the on-site evaluation, the airport must supply contemporary proof for each standard that occurred within the past calendar year and must also provide annual proofs from the prior twelve months. Re-accrediting airports are subject to the IAAA accreditation standards in effect at the time of successful completion of the mock assessment.

Phase 2 is the file maintenance phase, whereby the airport must keep current files to support each standard met. Files may be electronic or hard copy. Any training provided must have the signature and date of the employee trained as a “proof.” This signature can be inked on hard copies or time stamped on electronic copies.

Phase 3 is self-assessment, where airports assess their ability to meet all IAAA accreditation standards addressing major airport areas as established by the Program's Professional Services Committee. Major areas include emphasis on:
Goals and Objectives
Role and Authority
Management Staffing, Organization
Records Management
Information Technology
Unusual Occurrences
Health and Safety
Fiscal Management
Recruitment and Selection
Training
Performance Evaluation
Code of Conduct

During the file maintenance and self-assessment phase, airports gather proof of their ability to meet the standards and proof of the airport's institutionalization of the standards. Airports are assigned a mentor during this phase that will assist them with many aspects of the accreditation process.

Phase 4 is the on-site assessment and evaluation phase. During the on-site assessment and evaluation phase, the on-site assessment team is a group of volunteer assessors from various airports across the country. The on-site assessment team evaluates the airport's ability to meet the IAAA accreditation standards. The Assessors review files for policies and procedures as well as documents (proofs) showing the airport is operating under the direction of those policies and procedures. Assessors also interview airport members to gather additional information and to see how well the policies and procedures are understood and communicated. As part of the IAAA on-site process, assessors are encouraged to recommend where improvements can be made. These volunteers are paid at an hourly rate. Results of the on-site and suggestion for improvement are compiled in the final on-site report. Non-compliance issues must be reconciled to the satisfaction of the Director of Professional Services before the airport presentation to the Accreditation Commission. All non-compliance issues must be resolved at least 30 days prior to the Commission meeting.

Phase 5 is the Accreditation Board of Commissioners review phase. In the Accreditation Commission review phase, the IAAA Director of Professional Services, the Chief Administrator of the airport seeking accreditation, and the departmental accreditation manager appears before the Accreditation Commission for determination if they have met all IAAA standards. When evaluating an airport's suitability for accreditation or re-accreditation, the findings of the Accreditation Commission is final.

Phase 6 is the Executive Director review phase, where the IAAA Executive Board reviews the findings of the Accreditation Commission and confirms a final decision. Phase 7 is the award phase, where the Airport is presented with a plaque and certificate for successfully achieving the professional standards as outlined by the International Association of Airport Accreditation. Phase 8 is the re-accreditation phase, where airports repeat the entire process. The re-accreditation process is significantly less cumbersome if airports institutionalize the accreditation philosophy and keep airport policies, procedures and records up to date. To maintain accreditation, airports must be re-accredited every 3 years.

The following are the considerations for accreditation by the Executive Director.
1. Commitment is everything. You must be totally committed to the effort and the outcome because, like everything that has meaning, the accreditation process is not easy and it will take hard work by numbers of people. Every airport has a pace to achieve accreditation and the time it takes for an airport to become accredited is different from airport to airport. One airport that “lived accreditation” may complete the accreditation program in 45 days, while another airport may take several months or years, especially if infrastructure changes are needed.
2. Contact IAAA. The accreditation standards are updated annually with new editions published each year. Standards are updated by the Professional Services Commission and approved by the Executive Board, after membership discussions, to reflect the evolution of the profession and to keep the program current. The airport is held to the version of the standards in effect at the time the accreditation contracts are signed with IAAA.
3. Scan the Standards for your own familiarity and to get a snapshot of the expectations. It is very likely that you are already doing the vast majority of standards but reviewing the standards will provide a foundation for your questions and give you a good impression of the areas that need addressing.
4. Plant Seeds. Plant the idea of accreditation with the key leadership and opinion-makers with the airport. This will likely prevent surprise and initial resistance.
5. Keep the elected officials informed and solicit their commitment. Accreditation is often widely accepted, if not popular, with elected officials because it is easy for them to comprehend. Meeting highest industry standards makes sense to elected officials and the public.
6. Contact IAAA. Notify the Director of Professional Services that you want to pursue accreditation. The Director will advise you of the resources that are available to you and will assign your airport an accreditation mentor (see below). Once you have completed a mock assessment and signed a contract with IAAA, your commitment becomes formalized. The date on which you sign your contract will determine which edition of the standards you will be assessed on.
7. Mentoring. Nearly all of the currently accredited airports will provide assistance to help you in your process. There is no need to pursue airport accreditation alone and working with a mentor is required and makes the process much easier. The IAAA Director of Professional Services will work with you to assign a mentor. A current mentor list is available on the IAAA website.
8. Identify an Accreditation Manager. This is the point person for your airport's accreditation effort. Successful Accreditation Managers: 1) Know the airport well; 2) Have a track history of getting projects done that meets your expectations; 3) Are team leaders who can delegate, motivates others, create teams, and get tasks done; 4) Are willing to learn, ask questions, and find resources; and 5) Are committed to seeing the process through to completion. The surest way to stall your accreditation effort is change managers during the process. Some airports have used their “up and coming” leaders as Accreditation Managers. Who you pick as the Accreditation Manager will set the tone for success. History has shown that selecting the “right person” for the job is better than using someone who is randomly assigned the accreditation task manager.
9. Train the Accreditation Manager. Training for Accreditation Managers is offered by IAAA during the year. The next level of training for the Accreditation Manager is to work as an accreditation on-site Assessor for IAAA. Just having an Accreditation Manager witness an on-site assessment is an excellent training experience. The IAAA Director of Professional Services can assist you with this opportunity.
10. Present the accreditation program to your command and supervisory staff, and then include the union leadership and all airport staff. Successful accreditation processes. Include all the components of the airport through the process of information sharing and delegating standards out to employees. Though it may seem easier to have the accreditation process be “top down” and completely done by the Accreditation Managers, the result fails to lift up the whole airport and the process becomes only an event, rather than a way of doing business.
11. Policy Modification Authority. The Accreditation Managers you select will recommend changes to airport policy and/or practice in order to institutionalize accreditation into your airport. Streamline the process by which policy can be modified to meet the standards and your personnel to the new standard. If the process for modification of policy and/or practice is too complex, the accreditation process may bog down and stall.

The following is what Accreditation Managers should consider for success.
1. Assess where the gaps are. This is determining where the airport's practices and policies may need work. Though it can be done by the Accreditation Manager it is often done more successfully and quickly by a small group of supervisors. The gap assessment becomes the primary task list of attaining accreditation.
2. Consult with a Mentor through the IAAA Mentorship program. Establish a relationship with a Mentor through the IAAA Mentorship Program. Mentors are selected by the Director of Professional Services, possess strong coaching skills and work in airports that have successfully completed the accreditation process. Mentors provide great insight into what is expected, to include file preparations and the actual Accreditation process.
3. Start a tracking system. Successful Accreditation Managers create an excellent tracking system to keep track of the standards that are done, ones that are in progress and who is working on them.
4. Research policies and practice to meet the standards. Though it is very likely that most of the standards will not need any work on your part because you are already doing them. When you find a “gap” that need to be filled, find the best policy or practice to close the gap. Borrow and modify policies from other accredited airports. Do not “reinvent the wheel”.
5. Implement. New written policy needs to be reviewed, approved and trained on. This may take longer than you think. Some airports use a quiz format to make sure the transfer of learning, from the policy book to the employee, actually happened. Document any policy training that occurs. This makes for an excellent proof for your file.
6. Focus on performance to meet the standard. This means that the on-site assessor will verify compliance of many standards by reviewing the proofs in the file, as well as interviewing the staff and taking airport tours of the facilities. Therefore, employees will need to know your policies and practices. This is why training of staff is vital.
7. Create a standardized system of file construction. All standards will need files for the on-site assessors to review. Experienced Accreditation Managers create a standardized way of constructing the files that are easy for the Assessor to use. Most managers create actual file folders for each standard to hold necessary documents. Other airports use an electronic format that is approved for IAAA accreditation purposes. If the airport elects to use an electronic file format you must seek prior approval from the Director of Professional Services.
8. Keep accreditation on the front burner. Do this by imposing short time lines for tasks and having many people involved in the work. Keep accreditation on the agenda for all staff and team meetings. Consider using a large bulletin board that is accessible to all employees to show the progress of the effort. Plan for distractions while not losing momentum on accreditation.
9. Do in-house assessments. Task a team of supervisors and go through all the standards, interviewing employees, observing practices and looking at files to determine if all of the standards are met.
10. Participate in another airport's mock or actual on-site assessment. One of the best ways to learn what to expect is to experience an on-site as an observer. Coordinate with the IAAA Director of Professional Services to observe an ongoing assessment.
11. Conduct a mock assessment. All airports seeking IAAA accreditation must experience a mock on-site assessment prior to their on-site assessment. Mock assessment is one of the most important steps in the accreditation/re-accreditation process and is normally facilitated by your airport's Accreditation Mentor. The Director of Professional Services will assist in identifying Accreditation Assessors willing to assist with a mock on-site. The value of a mock assessment is to find the “blind spot” that is often overlooked and to provide you with an opportunity to fix issues that may be identified prior to your on-site. An Accreditation Agreement, between IAAA and the accrediting airport, is signed once the mock assessment has been successfully completed.

The following is what is to be expected during the on-site assessment process.
1. Schedule the dates with IAAA. The dates are mutually agreed upon between you and the IAAA. Give yourself enough time to be successful, but short enough time that it stays a priority. Typically, an on-site assessment takes one day.
2. In the event that the Director of Professional Services is unavailable to facilitate the on-site they will assign a team leader. The team leader will be looking for opportunities to find compliance with the standard without affecting the standard's integrity.
3. Parking for Assessors. Some airports have very limited general parking opportunities and airports may find it beneficial to reserve parking for Assessors.
4. Provide general information to each Assessor: folders containing maps, photos of command staff, telephone numbers, locations of offices and restrooms are helpful. Also, copies of the airport's policy manual, Comprehensive Emergency Management plan and other documents from which proof are taken should be available for Assessors to review on a nearby resource table.
5. Designate a conference room for Assessors. A space that can comfortably handle 6-8 people with lap top computer, surface to spread out files, a white board and light snacks are appropriate.
6. Provide name tags and access to the buildings and the security perimeter.
7. Refreshments and Lunch. It is the Airports responsibility to provide morning refreshments and lunch to the Assessors. Lunch should be brought in to allow the on-site team to work throughout the day.
8. Start the on-site assessment with introductions of key staff members and a tour of the facilities. A greeting by the Airport Director or top administrators is sometimes appropriate and is at the discretion of the Director. This answers a lot of questions and gets the assignment off to a good start.
9. Have enough staff on hand to answer questions without impacting the services to the aviation community. Avoid having the Assessors wait for long periods of time for staff members to be available. Some Assessors may want to do a short (1 hour or so) ride along with Airport Operations, Aircraft Rescue and Firefighting (ARFF) or Maintenance. To interview them and to watch them at work.
10. The team leaders will keep you informed. One of the key roles of the IAAA Director of Professional Services or team leaders is to keep the Airport Executive informed of the progress of the assessment.
11. Closing out the Assessment. The team leader and the Assessor will provide the Airport Executive and any other invited airport employees with a summary of their findings. This is a great time to hear everything that the Assessor found. Remember, the Assessor only provides a report with recommendations to the Accreditation Committee about compliance with IAAA Accreditation.
12. Final Reports. The Director of Professional Services will compile the assessment team's final report and this will be sent to you before the Accreditation Committees meet. Review the report carefully and communicate any concerns or questions to the IAAA Director of Professional Services.
13. The Accreditation Commission. The Accreditation Commission will meet regularly to consider awarding IAAA accreditation to the airport. The Commission may hear from the IAAA Director of Professional Services and the Airport Executive is encouraged to be part of the process. They may choose to speak or make an appeal about any of the assessment team's findings. If the Commission agrees with the findings or the report, the recommendation for accreditation will be forwarded to the IAAA Executive Board for final action.
14. IAAA Conference for the Award. The award is given at a banquet. It is appropriate that the Chief Executive and the Accreditation Manager receive the award on behalf of the airport. Many airports will bring a contingent to the banquet and fill a table of four or eight. Accreditation remains in effect for 3 years.
15. Celebrate. Consider presenting the award plaques to your elected officials or citizens at a public meeting with the media present. The local print media are usually very good at covering these events. Consider having a reception with the airport's team and honor the Accreditation Managers for their work. Take the accreditation plaque on the road as a topic to speak to service organizations and neighborhood groups. Put the plaques in a prominent place for the public to see. You may want to display “International Accredited Airport” on your letterhead, business cards and/or service vehicles. Promoting the accreditation promotes your excellence.
16. Be a Partner and Mentor. Use your lessons and expertise to help your neighbor airports, continue to live the accreditation standards, and participate on assessment teams as the program continues to grow.

The Accreditation Commission should meet regularly to review accreditation reports submitted to the Director of Professional Services. During the Commission meeting, the Director of Professional Services present the onsite reports and summarizes the results of all on-site assessments that have been conducted since the last meeting. The Commission is comprised of two Airport Directors from accredited airports; two Deputy Directors from accredited airports; three Accreditation Managers from accredited airports. The Commission may add additional members as it sees fit. The IAAA Executive Board makes appointments to the Accreditation Commission. Terms are for three years and are on staggered expirations so as to provide process consistency and to ensure experience on the Commission. A list of current Commission members is available on the IAAA website. The Chairperson of the Commission is selected from the Commission Members and serves in that capacity for one year. The IAAA Director of Professional Services provides staff support for the Commissions. The Commission is not a file assessment entity, and as such, will not review files for compliance of standards. The Commission reviews the reports of the assessment team to determine that they have followed the process and completed the necessary reports and answered any unresolved issues or findings.

In the event that there is a dispute between the assessment team and the airport seeking accreditation that cannot be resolved through the Director of Professional Services, the Commission will hear appeals concerning compliance/non-compliance with the standards set forth in the IAAA Standards Manual. Once the process has been verified and any appeals resolved, the Commission makes recommendations to the IAAA Executive Board to convey accreditation status upon the requesting airport.

The Professional Services Committee should meet regularly, but may also meet periodically during the year to review standards, provide training or to review assessment schedules and procedures. To ensure the Accreditation Program remains a viable gauge of professional standards, the Commission reviews and recommends updates to standards to the Executive Board.

The Commission's Philosophy is:
1. Accreditation is voluntary
2. Accreditation is intended to be the minimal professional standard for airports.
3. Accreditation should be accessible and affordable to any airport.
4. All standards are mandatory and apply to all airports. Every part of the standard must be met. Some standards have multiple elements; each must be proofed.
5. The origins of the mandatory standards are: Requirements of the aviation industry, federal guidelines or universal recommendations of “best” practice by the IAAA. The threshold for every standard is the “necessity of practice by every airport” or “universal have-to.” Standards are reviewed and adopted using a formal and accessible process during the Professional Services Committee meetings. Standards may also be derived from IAAA Model Policies which are recommended from the IAAA Model Policies Commission to the Executive Board.
6. The standards are not intended to dictate which practices, policies or guidelines that an airport should have; only that the airport's product is reasonable, appropriate and defensible as it meets the standard's requirement.
7. Purpose statements in standards are intended for guidance and clarification only; they are not required, but airports should expect the standard's requirements to be interpreted according to the listed purpose.
8. Absent unusual circumstances, new and updated standards are published annually. An airport that is undergoing accreditation or re-accreditation, and is under contract, is responsible for the standards in effect on the date that the airport successfully completed their mock assessment.
9. During the initial airport on-site, proofs from the most current year will be inspected for compliance. Airports seeking re-accreditation will be expected to provide proof of compliance from the period between their last accreditation on-site and the re-accreditation on-site. In the event a standard asks for compliance with an audit or the production of an annual report, the most current copy of the audit/annual report will suffice as proof in the accreditation file. Additionally, the airport must also have available for Assessor review, proofs of compliance for each year between onsite assessment.
10. The duration of an airport's accreditation is 3 years.

IAAA's Director of Professional Services is responsible for being the primary contact for airports considering accreditation or for those pursuing re-accreditation. As the primary clearing house for all aspects of IAAA accreditations they:
1. Assign resources and advice to airports initiating the accreditation process.
2. Coordinate the revision and update of standards that are forwarded to the Accreditation Committee for review and approval.
3. Recruit and assign Accreditation Mentors and ensure the list on the IAAA web site is current.
4. Schedule on-site assessment of the airport seeking accreditation or re-accreditation, assemble the assessment team, completes the final report and briefs the Accreditation Commission on team findings.
5. Coordinates training of Assessors and Accreditation Managers.

The following is the Accreditation Standards to be followed during the accreditation process. There are 22 chapters to the Accreditation Standards.

### Chapter 1—Goal and Objectives

1.1 The airport has a written vision and/or mission statement that defines the airport's role.
1.2 The airport has a strategic plan or written goals and objectives that are reviewed and updated at least annually and are available to all personnel and the public.

### Chapter 2—Role and Authority

2.1 The airport has policies specifying legal requirements and procedures for any unusual occurrence.
2.2 The airport has policies and procedure regarding the detention of any Foreign Nationals.

### Chapter 3—Wildlife Mitigation, Medical Aid, Drones and Unauthorized Aircraft and Vehicles

3.1 The airport has policies and procedures for wildlife mitigation.
3.2 The airport has policies and procedures for addressing unauthorized drones on or near airport property, and is in compliance with FAA directives.
3.3 The airport has a Policy requiring appropriate medical aid and procedures to attend to employees and/or non-employees.
3.4 The airport has a policy and plan for the reporting and intervention of unauthorized aircraft and vehicles on the airport operations area.

### Chapter 4—Management, Staffing, Organization, and Utilization of Personnel

There are several different types of terms used to “denote the top leadership position of an airport, such as “Director”, “Manager”, “President” etc. that are interchangeable and synonymous with each other.
4.1 The airport has a protocol and procedure for situations including the following:
   Absence of the Director
   Exceptional situations involving different specialty units deployed in a common joint operation
   Routine, day-to-day operations
   The airport is meeting part 139 requirements or best practices
   The airport has corrected all discrepancies from prior audits
   Part 139 airports have at least 2 daily inspections (am and pm) of the movement area
   Non-part 139 have at least one daily inspection per day
4.2 The airport has a policy that requires personnel to obey any lawful order of a supervisor and also addresses conflicting orders or unlawful orders. Labor agreements and grievances procedures should be clear.
4.3 The airport has a policy that requires an annual management review and analysis, with final review approved by the Director or their designee, of the following:
   Vehicle operation in the airport operations area
   Internal disciplinary investigations
4.4 The airport has a system of written directives that include procedures for developing, approving and disseminating directives to all personnel. The system will include:
   Methods for tracking changes and archiving prior versions of policies
   A process that confirms receipt of directives by affected personnel

### Chapter 5—Record Management

5.1 The airport has a standardized record management system.
5.2 The airport has policies governing its compliance with all rules for computer program participation to include:
   The airport can show 100% compliance of its' own security and tasking
   The airport can show that all personnel have been trained and certified in computer operations and security
5.3 The airport physically protects the privacy and security of airport records in a manner that assures that only authorized personnel with the appropriate need to know- and right to know can access those records.
5.4 The airport complies with local rules and regulations regarding disposal and retention of records.
5.5 The airport has guidelines to address the release of public information to the media.
5.6 The airport has policies and procedures for intervening in potential human trafficking.
5.7 The airport has policy and procedures for the lawful impoundment of vehicles on airport property.

### Chapter 6—Information Technology

6.1 Access to the airport's computer system is secure with restricted access to those who are authorized and who have passed a background investigation process.
6.2 The airport can show 100% compliance or that it has made corrections to comply with any negative findings from the previous technical audit.
6.3 The airport has policies governing appropriate use of airport technology.
6.4 Each fixed and mobile computer workstation has an up-to-date copy of airport approved, security software installed and running while the equipment is in use.
6.5 Electronic information is routinely backed-up at least once a week, or maintained on a secure server. Back-up data is kept in secure storage and is completely destroyed when no longer needed.

### Chapter 7—Unusual Occurrences

7.1 Every airport staff member is familiar with the National Incident Management System (NIMS) and Incident Command System (ICS) introductory training courses.
7.2 Each airport supervisor has completed and is certified in the National Incident Management System (NIMS) and Incident Command System (ICS).
7.3 The airport has plans for responding to natural and man-made disasters, civil disturbances, and other unusual occurrences.
7.4 The airport works with the county and/or regional agencies in developing a county or regional disaster or emergency response plan.
7.5 The airport has a policy and procedure for requesting and providing mutual aid.
7.6 The airport has a policy and procedure for how to handle an unauthorized aircraft or vehicle on the ramp or taxi-way.
7.7 The airport has supplies to support its' personnel in the event of an emergency declaration.

### Chapter 8—Health and Safety

8.1 The airport has written guidelines that inform employees of the threats and hazards associated with bloodborne and airborne pathogens.
8.2 The airport provides personal protective equipment (PPE), which shall include latex gloves, (or equivalent), eye protection, protective shoe covers, masks and sanitizer to minimize exposure to potentially infectious materials and objects.
8.3 The airport will conduct training in bloodborne and airborne pathogens annually.
8.4 The airport provides reflective clothing and requires its use on certain hazardous airport property.
8.5 The airport has procedures for disposal and decontamination when there is an event or contact involving biohazard materials including blood or bodily fluids.
8.6 The airport has procedures for post-exposure reporting and follow-up after suspected or actual exposure to infectious diseases.
8.7 Administrative support employees are physically separated from the public by a physical barrier.
8.8 The airport requires all employees to use safety restraint/seat belts while operating airport vehicles both on and off airport property.
8.9 Employees are required to receive annual vehicle safety training for both movement and non-movement areas. This includes physical skills testing and documentation. FBO's (Fixed Base Operators) are also required to ensure their employees are trained for operation in the non-movement and movement areas. Documentation is required.
8.10 The airport complies with all local fire regulations.
8.11 Employees must be certified in the use of fire extinguishers, AED's, CPR and

basic first aid annually.

### Chapter 9—Fiscal Management

9.1 The Director and Assistant Director have the authority to spend funds in the approved budget for day-to-day operations of the airport.
9.2 The Director or Assistant Director makes regular reviews of the airport budget and documents those reviews.
9.3 The airport has a system for reviews and approval of expenditures.
9.4 The airport has a policy requiring supervisor approval of all overtime.
9.5 The airport requires supervisor approval for all employee timesheets.
9.6 The airport has a system to document and record the use of cash funds that include receipts, supervisor approval, and periodic audits.
9.7 The airport has an effective proactive asset management system.
9.8 The airport has a budget for needed staff, programs and resources.
9.9 The airport has qualified staff or contracted services capable of conducting accounting, financial analysis and producing applicable reports.
9.10 The airport has staff and processes in place to manage inventories, audits and application of internal controls.
9.11 The airport has trained staff to process the procurement of equipment and manage contracts.
9.12 The airport has demonstrated that it has successfully managed the financial function for the past rating period.

### Chapter 10—Recruitment and Selection

10.1 The airport has written standards and hiring criteria for all employees and, if applicable, interns or part-time employees.
10.2 The airport requires that a background investigation be conducted on each employment candidate as a condition of employment and that the results of that investigation be documented for further review.
10.3 Employee personnel files are separated and secured from other files.
10.4 Application for employment files are secure and available only to those who are authorized to participate in the selection process.
10.5 The airport has programs and events directed towards the area youth which are intended to showcase the airport and aviation.

### Chapter 11—Training

11.1 The airport has established a formal training program for all employees that include:
   On the job training, acclimating the employee to the aviation and airport culture
   Regular documentation of the employee's progress
   Requiring the employee to meet expectation standards prior to achieving full-employment status.
   “On-boarding” checklist for all new employees and interns
11.2 The airport maintains records of each formal training it conducts, to include:
   Course content/lesson plan
   Performance of attendees
   Credentials of the presenter or instructor
11.3 Staff members who are designated as full-time supervisors or managers have earned the appropriate certifications.
11.4 Annually, airport employees receive in-service training on the airport's mission, vision and goals and their part in achieving those values and goals.

### Chapter 12—Performance Evaluations

12.1 The airport has an evaluation policy that requires formal written reviews of the work performance of each employee and is conducted annually.
12.2 The airport has a system for evaluating the performance of all probationary employees, interns or part-time employees.

### Chapter 13—Code of Conduct

13.1 The airport has a code of conduct that provides clear expectations for all employees and includes guidelines for speech, expression and social networking.
13.2 The airport has a policy prohibiting sexual and any other form of unlawful or improper harassment or discrimination in the work place. The policy provides guidelines for reporting unlawful or improper conduct, including how to report if the offending party is in the complainant's chain-of-command. The policy includes “whistleblower” protections.
13.3 The airport has an alcohol and drug use policy, or language contained in local collective bargaining agreements, that addresses drug and alcohol use, and includes language that covers employees suspected of drug and/or alcohol abuse and their fitness for employment.

### Chapter 14—Misconduct Investigation

14.1 The airport requires the documentation and investigation of all complaints of misconduct against airport employees.
14.2 The top leadership position of the airport or their designee identifies which complaints are investigated, and who investigates them.
14.3 The airport has procedures for relieving an employee from duty.
14.4 The airport has a policy where complainants are provided with notification concerning the disposition of the complaint.
14.5 The airport maintains records of complaints and their disposition.
14.6 Misconduct procedures will be conducted in compliance to recognized organized Labor Union rules when applicable.

### Chapter 15—Operational Standards

FAA standards govern all United States and their territory's requirements for training and equipment.
15.1 The airport provides responses to emergency events 24/7 by employees who have completed basic and advanced training.
15.2 The airport has procedures for responding to emergency and non-emergency calls for service.
15.3 The airport has written guidelines and policy for the use of airport vehicles, including large special vehicles like sweepers and blowers.
15.4 The airport has procedures for investigating vehicle collisions on airport property.
15.5 The airport has procedures to take timely action to address hazardous conditions.
15.6 The airport has procedures for utilizing public and private alert systems.
15.7 The airport has procedures for the handling of mentally ill individuals, including those with pending criminal charges and mental health commitments.
15.8 The airport has a staffing plan for 24-hour operations or hours of operations, including “on call”.
15.9 The airport operations staff has task specific training (including staff that perform multiple tasks, such as “Maintenance” and “ARFF” functions or has contracts in place to address these requirements.

### Chapter 16—Investigative Functions

16.1 The airport has written guidelines and training for recognizing and acting on suspected domestic, elderly and child abuse.
16.2 The airport has written guidelines and training for recognizing and acting on suspected human trafficking.
16.3 The airport has policies and procedures governing the use of information generated at the airport.
16.4 The airport is familiar with and acting in harmony with the “Blue Lightning” reduction of human trafficking program.

### Chapter 17—Property Control

17.1 The airport has procedures for proper collection, documentation and security of found property.
17.2 The airport has policies requiring efforts are made to identify and notify owners of found property. Efforts are documented.
17.3 The airport has a policy that requires that property is placed in a secure location and logged in, before the finder secures from shift. If property is released to a second party, such as police authorities, this must be documented.
17.4 The airport has the means to properly secure found property, including perishable items.
17.5 The airport has the means to secure hazardous materials until they can be either stored or disposed of.
17.6 The storage area must be secure and alarmed or monitored for fire or unauthorized entry.
17.7 Access to the secured storage area is restricted to authorized employees.
17.8 The airport has a record of the name, date, time and purpose of persons who enter and leave the storage facility.
17.9 The airport provides additional security for guns, drugs, cash, jewelry or other sensitive or valuable property.
17.10 Every piece of property is related to a report describing the circumstances of how the property came to be in the airport's possession.
17.11 The airport has policies governing the release of property and documentation.
17.12 The airport has a policy regarding disposing of hazardous property with documentation.
17.13 When property is sold, the disposition of the monies received is accounted for and recorded accordingly per local laws.
17.14 The airport has a policy and procedure on how to handle illegal drugs, weapons or contraband.
17.15 The airport ensures that an unannounced audit is conducted annually of the secure room focusing on guns, drugs, monies, and jewelry.

### Chapter 18—Patron Security

18.1 The airport has written guidelines for transporting the sick, mentally ill, injured or disabled patrons.
18.2 The airport requires transporting employees to search patrons prior to transport in airport vehicles.
18.3 The airport requires that employees search airport vehicles prior to the transport of patrons and that any items found be documented and its' status can be determined on the report.
18.4 The airport has written policy on the detention and holding of patrons.
18.5 The airport has a policy about transporting non-airport personnel in airport owned vehicles.
18.6 The airport has a legal “Hold Harmless” agreement form for non-airport employees to ride in airport vehicles or on airport-controlled property.

### Chapter 19—Engineering, Runway Maintenance and Environment

19.1 The airport has addressed environmental concerns from the industry and local communities.
19.2 The airport has maps of in-ground utilities.
19.3 The airport has policy and procedures in place to protect ground water.
19.4 The airport has a secure water supply.
19.5 The airport has a flora and fauna biologist on staff or on contract.
19.6 The airport has complied with all FAA advisory circulations pertaining to all in-progress projects for the last 12 months.
19.7 The airport has project managers trained in engineering or access to trained engineers via contract.
19.8 The airport meets all state, local and federal regulations for water protection.
19.9 The airport has staff or contracts for runway construction.
19.10 The airport has a plan for runway replacement when the runway or surrounding areas have exceeded their life-cycle.
19.11 A Part 139 airport has staff or contracts for runway rubber removal.
19.12 The airport regularly tests for surface friction for airports within the snow-belt. This is not required for runways outside of the snow-belt.
19.13 The airport is meeting the current pavement condition index.
19.14 The airport has redundant systems in place for key safety functions.
19.15 The airport is using current “best practices” in managing the engineering tasks, and being transparent.
19.16 The airport has a plan for noise mitigation.
19.17 The airport has a plan for reducing the airport's carbon footprint.
19.18 The airport support vehicles (maintenance, ARFF, Operations) have fuel spill kits, first aid kits, AED and fire extinguishers.
19.19 The engineering support group participates in community outreach/involvement events.

### Chapter 21—Aircraft Rescue, Firefighting, Advanced First Aid

21.1 The airport has an aircraft rescue unit or has a contract with a fire entity that has training in advanced aircraft firefighting and rescue.
21.2 The airport has an aircraft rescue unit or contracts with a fire entity that has training in advanced first aid.
21.3 The airport has an aircraft rescue unit or contracts with a fire unit trained in advanced firefighting and has modern equipment. The users of the equipment have been trained and certified for their use.
21.4 There are up-to-date maintenance records on the specialty equipment.
21.5 The airport has specialized fire and rescue vehicles or contracts with an entity that does.
21.6 The operators of these vehicles have been trained and certified or contracts with trained and certified personnel exist.
21.7 The aircraft rescue and firefighting unit or the contract equivalent have appropriate PPE (Personal Protective Equipment) for firefighting in an aircraft environment
21.8 The Aircraft rescue and firefighting unit have the appropriate PPE for performing medical aid
21.9 The airport has a mutual aid plan in place for emergencies
21.10 The ARFF unit has a hazardous material plan, along with trained technicians to deal with hazardous materials.
21.11 The airport has vehicles or contracts with a fire unit that can disperse fire retardant foam (the product that is certified by the FAA-Currently AFFF).
21.12 The ARFF unit drills quarterly for emergencies.
21.13 The ARFF unit drills with its mutual aid partners at least twice per year.
21.14 The ARFF unit participates in Community outreach/involvement.

### Chapter 22—Innovations in Aviation-(Non-Rated)

22.1 The airport has considered the use of drones for commerce or deliveries.
22.2 The airport has considered the use of drones to deliver people to the airport (cabs).
22.3 The airport has considered the use and development of electric airplanes.
22.4 The airport has a plan to review advancements in aviation.
22.5 The airport has invested in a GIS system.
22.6 The airport is participating in the GBAC (Global Biorisk Advisory Council) program.
22.7 The airport owned property is clean, well-groomed and inviting to patrons and customers.
22.8 The airport is involved and aware of emerging technologies in the aviation industry and how they apply to airport management.
22.9 The airport has secured specialized aviation specific legal counsel either on staff or on contract.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

1. A method for an airport accreditation process for an airport to meet specific airport standards that earns the airport the title of “World Class”, comprising the steps of:
Performing Phase 1 of interest and contract, wherein airport staff works with the Director of Professional Services to develop guide lines for the airport and staff/resources, where there are fees associated with the accreditation process such as application fees and on-site costs, travel and lodging, where the application fee is submitted with a signed contract following the airport's successfully completing all current IAAA accreditation standards, where a signed contract with IAAA by the airports seeking initial accreditation will have one-year to complete an onsite assessment of the airport;
Performing Phase 2 of file maintenance, where the airport must keep current files to support each standard met, including any training provided to employee have a signature and date of the employee trained as a proof of training;
Performing Phase 3 of self-assessment, where the airport assesses their ability to meet all IAAA accreditation standards addressing major airport areas as established by the program's Professional Services Committee, where there is major areas emphasis on goals and objectives, role and authority, management staffing, organization, records management, information technology, unusual occurrences, health and safety, fiscal management, recruitment and selection, training, performance evaluation, and code of conduct, whereby during the file maintenance and self-assessment phases, the airport gathers proof of the ability to meet the standards and proof of the airport's institutionalization of the standards;
Performing Phase 4 of on-site assessment and evaluation, where during the on-site assessment and evaluation phase, the on-site assessment team is a group of volunteer Assessors from various airports, the on-site assessment team of Assessors evaluates the airport's ability to meet the IAAA accreditation standards, review files for policies and procedures as well as documents showing the airport is operating under the direction of those policies and procedures, where Assessors also interview airport members to gather additional information and to see how well the policies and procedures are understood and communicated, where Assessors are encouraged to recommend where improvements can be made, where results of the on-site and suggestion for improvement are compiled in the final on-site report, where non-compliance issues must be reconciled to the satisfaction of the Director of Professional Services before the airport presentation to the Accreditation Commission, where all non-compliance issues must be resolved at least 30 days prior to the Commission meeting;
Performing Phase 5 of a review by the Accreditation Board of Commissioners, where the IAAA Director of Professional Services, the Chief Administrator of the airport seeking accreditation, and the departmental Accreditation Manager appears before the Accreditation Commission for determination if the airport has met all IAAA standards and where findings of the Accreditation Commission of evaluating an airport's suitability for accreditation is final;
Performing Phase 6 of an Executive Director review, where the IAAA Executive Board reviews the findings of the Accreditation Commission and confirms a final decision;
Performing Phase 7 of an award, where the airport is presented with a plaque and certificate for successfully achieving the professional standards as outlined in the International Association of Airport Accreditation.

2. The method of claim 1, wherein there is a re-accreditation Phase 8 every 3 years, where the airport repeats the entire process, where the airport subject to re-accreditation is notified of the up-and-coming re-accreditation by the Director of Professional Services in the fall prior to the re-accreditation year; wherein the airport will have an agreed upon timeline of the re-accrediting year to successfully complete a re-accreditation on-site; wherein airports not re-accrediting by a pre-determined date are suspended the following year and must re-apply as a new accrediting airport the second year; wherein the airport must supply contemporary proof for each standard that occurred with the past calendar years and must also provide annual proofs from, at least the past year; and wherein re-accrediting airports are subject to the IAAA accreditation standards in effect at the time of successful completion of a mock assessment.
